(19) United States
(12) Patent Application Publication
(10) Pub. No.: US 2008/0145627 A1
(43) Pub. Date: Jun. 19, 2008

(54) Nanoscale masking and printing using patterned substrates

(75) Inventor: Christopher Knutson, Chicago, IL (US)

Correspondence Address: AKERMAN SENTERFITT, 801 PENNSYLVANIA AVENUE N.W., SUITE 600, WASHINGTON, DC, 20004, US

(73) Assignee: ARRYX, INC., Chicago, IL (US)

(21) Appl. No.: 11/822,215

(22) Filed: Jul. 3, 2007

Related U.S. Application Data
(60) Provisional application No. 60/817,699, filed on Jul. 3, 2006.

(51) Int. Cl. B32B 3/08; B05D 5/00; B32B 33/00

(52) U.S. Cl. 428/206; 427/197; 428/402

(57) ABSTRACT

Nanoscale masking using particles patterned on a substrate include assembling particles into a pattern on a first substrate; contacting the particles with a second substrate; adding blocking molecules while the particles are in contact, such that blocking molecules bind to portions of the second substrate not in contact with the particles; and separating the substrates, yielding a functionalized substrate having blocking molecules bound thereto. Nanoscale printing methods include assembling particles into a desired pattern on a first substrate; contacting a print material with the particles such that at least a portion of the print material binds to the particles on the first substrate; removing the first substrate having particles thereon from unbound print material; contacting the particles having print material bound thereto with a second substrate such that at least a portion of the print material binds to the second substrate; and separating the substrates, yielding a printed substrate.

### RELATED APPLICATION

This patent application claims the benefit of priority to U.S. Provisional Patent Application No. 60/817,699, filed on Jul. 3, 2006, the contents of which are herein incorporated by reference in its entirety.

### FIELD OF THE INVENTION

Example embodiments of the present invention are generally directed to methods of masking and printing using particles patterned on a substrate. Example embodiments also include modified or printed substrates made by the present methods. Such modified or printed substrates may be functionalized for various purposes including making copies of the original patterned substrate. Example embodiments also include products made utilizing such substrates. Further included are systems and kits for performing these methods, and systems for using substrates and products produced by such methods.

### BACKGROUND

Structures formed from colloidal particles hold great promise for applications that reach across a wide variety of fields. These structures typically consist of particles with diameters of a few nanometers to a few microns and can be formed from a wide variety of materials with specific chemical morphology.

### SUMMARY OF THE INVENTION

The present invention is generally directed to masking and printing methods that may be useful for example, in nanoscale guided self-assembly, genomic analysis, such as nanoprinting for genome chips, and photonic crystal devices. The present methods allow the creation of user-specified patterns of microparticles on a substrate (for example, using the HOT process, without the need to use lithography), and further provide the ability to use those patterned microparticles as a mask or for printing, to produce functionalized substrates that can be used to make e.g., a copy of the patterned microparticles. This capability to produce functionalized substrates with features on a nanometer length scale is highly desirable for example, for genomic analysis and nanoscale self-assembly.

Example embodiments are directed to methods of masking using particles patterned on a substrate. Such methods may include assembling multiple particles into a desired pattern on a first substrate; contacting the particles with a second substrate; adding blocking molecules while the particles are in contact with the second substrate, such that blocking molecules bind to portions of the second substrate not in contact with the particles; and separating the first and second substrates, to yield a functionalized substrate having blocking molecules bound thereto. These methods may optionally include sintering or cross-linking the patterned particles on the first substrate. These methods may also include adding linker molecules to the particles before contacting them with a second substrate. By way of non-limiting example, the particles may be colloidal particles.

Example embodiments are also directed to methods of printing using particles patterned on a substrate. Such methods may include assembling multiple particles into a desired pattern on a first substrate; contacting a print material with the particles such that at least a portion of the print material binds to the particles on the first substrate; removing the first substrate having particles thereon from unbound print material; contacting the particles having print material bound thereto with a second substrate such that at least a portion of the print material binds to the second substrate; and separating the first and second substrates, thereby yielding a printed substrate. These methods may optionally include sintering or cross-linking the patterned particles on the first substrate. These methods may also include adding linker molecules to the particles before contacting the print material with the particles.

Example embodiments also include modified or printed substrates made by the present methods. Such modified or printed substrates may be functionalized for various purposes including making copies of the original patterned substrate.

Example embodiments also include products made utilizing such substrates.

Example embodiments also include kits for performing the above methods, which may include for example, apparatuses for patterning particles on a substrate, particles, substrates, blocking molecules, print material, linker molecules and the like.

Further example embodiments include systems for performing these methods and systems for using substrates and products produced by such methods.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other methods, structures, and systems for carrying out the several purposes of the present invention. It is important, therefore, that the claims be regarded as including such equivalent constructions insofar as they do not depart from the spirit and scope of the methods and apparatuses consistent with the present invention

### BRIEF DESCRIPTION OF THE DRAWINGS

Embodiments of the invention are herein described, by way of non-limiting example, with reference to the following accompanying drawings:

FIG. 1 is a perspective view of a sample cell, which may be used in accordance with non-limiting example embodiments.

FIGS. 2(a)-2(b) depict side views of possible methods of assembling and patterning particles on a substrate, in accordance with non-limiting example embodiments;

FIG. 2(c) depicts a side view of optional sintering together of particles on a substrate, in accordance with non-limiting example embodiments;

FIG. 2(d) depicts a side view of particles on a substrate that are not sintered together, in accordance with non-limiting example embodiments;

FIGS. 3(a) and 3(b) depict side views of adding a modifier or linker molecule to patterned particles on a substrate in accordance with non-limiting example embodiments;

FIGS. 4(a)-4(d) depict side views of steps in a masking process, where a modifier or linker molecule as in FIGS. 3(a) and 3(b) have been added to patterned particles on a substrate, in accordance with non-limiting example embodiments;

FIG. 4(e) depicts a top view of a substrate that has been functionalized with a modifier or blocking molecule in accordance with non-limiting example embodiments of the masking process depicted in FIGS. 3 and 4;

FIG. 5 depicts a particle to exhibit how the Chord Theorem may affect masking in accordance with non-limiting example embodiments;

FIGS. 6(a) and 6(b) depict side views of adding a modifier or linker molecule to patterned particles on a substrate in accordance with non-limiting example embodiments;

FIGS. 7(a)-7(c) depict side views of steps in a printing process, wherein a modifier or linker molecule as in FIGS. 6(a) and 6(b) have been added to patterned particles on a substrate, in accordance with non-limiting example embodiments;

FIGS. 8(a)-8(c) depict side views of steps in a printing process, in accordance with non-limiting example embodiments, where a printing material or ink is added directly to patterned particles on a substrate, with no modifier or linker molecule therebetween;

FIG. 9(a) is a brightfield image of a plurality of particles that are trapped and separated in the sample cell of FIG. 1, in accordance with non-limiting example embodiments;

FIG. 9(b) is a brightfield image of the particles of FIG. 9(a), being combined into a two-dimensional (2D) simple square lattice pattern, in accordance with non-limiting example embodiments;

FIG. 9(c) is a brightfield image of the particles of FIG. 9(b), formed into three 3×1 arrays until a 3×3 crystal is formed, in accordance with non-limiting example embodiments;

FIG. 9(d) is a brightfield image of the crystal of FIG. 9(c), which is rotated 90° above the substrate about an axis parallel to the coverslip, in accordance with non-limiting example embodiments;

FIG. 9(e) is a brightfield image of the crystal of FIG. 9(d), rotated again by 45° before being deposited on the substrate, to produce a 3×3 crystal, in accordance with non-limiting example embodiments;

FIG. 10 is a brightfield image of a three-dimensional, two layer colloidal crystal of silica particles formed on the glass coverslip substrate, in accordance with non-limiting example embodiments;

FIG. 11(a) is a brightfield image of the complete colloidal crystal structure formed from two populations of differently sized silica spheres, in accordance with non-limiting example embodiments; and

FIG. 11(b) is a brightfield image of the same structure as in FIG. 11(a) after the aqueous phase has been removed, in accordance with non-limiting example embodiments.

### DETAILED DESCRIPTION OF THE EXEMPLARY EMBODIMENTS

The aspects, advantages and/or other features of example embodiments of the invention will become apparent in view of the following detailed description, which discloses various non-limiting embodiments of the invention. It is to be understood that each specific element includes all technical equivalents that operate in a similar manner to accomplish a similar purpose.

The present methods include masking and printing methods that may be useful for example, in nanoscale guided self-assembly, genomic analysis, such as nanoprinting for genome chips, and photonic crystal devices. The present methods are advantageous for example, in that the creation of the mask or printhead does not require traditional lithography. Moreover, nanometer resolution may be accomplished with the use of micro-scaled colloids as the relevant printing dimension is determined by only the contact area of a sphere and a plane. This allows the device to have nanoscopic, rather than microscopic dimensions. Also provided are functionalized and printed substrates produced by the present methods and products that utilize such substrates. Further provided are kits and systems for performing the methods provided herein, as well as kits and systems that include the substrates or products produced by the present methods.

Example methods and devices may be adapted for many different purposes and are not intended to be limited to the specific example purposes set forth herein. Those skilled in the art would be able to adapt the methods and devices of the present invention, depending for example, on the intended use, e.g., by selecting the materials, order of steps, etc.

As used herein, “a” or “an” may mean one or more. As used herein, “another” may mean at least a second or more.

An example application of the present invention is in masking. Masking methods provided herein may form for example, a functionalized substrate having a modifier on the surface thereof, where the modifier is formed in essentially a reverse image of patterned particles forming the mask.

According to non-limiting example embodiments, methods are provided that include assembling multiple particles into a desired pattern on a first substrate; directly or indirectly (e.g., via a modifier such as a linker molecule) contacting the particles with a second substrate; adding blocking molecules while the particles are in contact with the second substrate, such that the blocking molecules bind to portions of the second substrate not in contact with the particles; and separating the first and second substrates to yield a functionalized substrate having blocking molecules bound thereto, and open spaces (with no blocking molecules bound thereto) where the particles were directly or indirectly in contact with the second substrate.

As indicated above, these methods include assembling multiple particles into a desired pattern on a first substrate, thus forming a template. According to example embodiments, the particles may be first formed into a desired configuration or pattern on a substrate.

Particles may include for example colloids, such as silica colloids or polystyrene colloids known to those skilled in the art. For example, the particles may be a monodisperse substance, a biological material such as a cell, vesicle, or a viral particle, a semiconductor material (such as semiconductor dots), or a photonic bandgap crystal. By way of non-limiting example, colloidal particles may be Bangs Labs #SS04N/5569 or silica spheres #SS059/4908. In example embodiments, the particles may be a material that is capable of producing an attractive van der Waals interaction with one another and/or a substrate. Particles patterned on the substrate may include one or more of the same or differing substances. Additionally, particles may be of the same or different sizes and/or shapes depending on the desired pattern. Characteristic (but non-limiting) sizes of the particles or cells may be from tens of microns to one nanometer.

The terms “colloidal particle,” “particle,” and “colloids” and the like are intended to encompass particles that may begin somewhat discrete from one another before the methods herein are performed. These terms are also intended to include such particles after they are attached to a substrate and/or other particles, e.g., by sintering or cross-linking. These terms are also intended to include such particles, regardless of shape and even if they are compressed to become for example, somewhat elongated in shape. Accordingly, the terms “colloidal particle,” “particle,” and “colloids,” “sphere,” “cells” and the like are intended to be very broad and encompass many shapes, including spheres, spheroids, wires, cylinders, rods, pellets, granules, blocks, grains or any other suitable shape.

The first substrate onto which particles may be formed may include for example a glass substrate, such as a glass coverslip. Other examples may include polymeric materials. According to example embodiments, the first substrate is optically transparent and capable of producing an attractive interaction with the particles, for example colloid particles (to lock them in place). According to example embodiments, the first substrate may include materials that are rigid, semi rigid, or flexible materials. The substrate may be substantially flat. Alternatively the first substrate may be a shape that substantially corresponds to a second substrate's shape such that patterned particles on the first substrate may be used as a mask for the second substrate (or in other embodiments described herein be used to print onto the second substrate). For example, if the first substrate is curved, it may be used in a masking process for a matching curved second surface.

Non-limiting example methods of producing substrates having particles assembled in a desired pattern thereon, may utilize particles, such as colloids, permanently affixed to a substrate via a van der Waals interaction. According to these examples, the particles may be charge-stabilized colloidal particles that may be manipulated into a desired configuration on a substrate using holographic optical trapping (HOT). Methods of assembling particles into a desired configuration on a substrate using holographic optical trapping (HOT) are described for example in U.S. Pat. No. 6,055,106 (Grier et al.), and assembling particles into a desired configuration using HOT is described in U.S. patent application Ser. Nos. 10/735,395 (Gruber et al., corresponding to U.S. Patent Publication No. 2004-0180363), and Ser. No. 11/484,598 (Knutson et al) filed on Jul. 12, 2006, the contents of which are herein incorporated by reference in their entirety.

In embodiments utilizing holographic optical tweezers to assemble the particles, an apparatus for assembling the particles may include holographic optical tweezers, which form optical traps; a sample cell including: a substrate; a sample chamber disposed on the substrate; an input tube into the sample chamber; an output tube from the sample chamber; a stable suspension of charge-stabilized particles; an electrolyte introduced into the sample chamber via the input tube; and a pH adjusted solution inputted into the sample chamber. The particles may be trapped by the holographic optical tweezers to form a desired structure on a substrate.

According to example embodiments, optical traps may be generated using a device such as the Arryx Bioryx 200™ system utilizing, for example, a 532 nm continuous wave laser (such as a Spectra Physics Millenia V) on an inverted microscope (such as a Nikon TE-200).

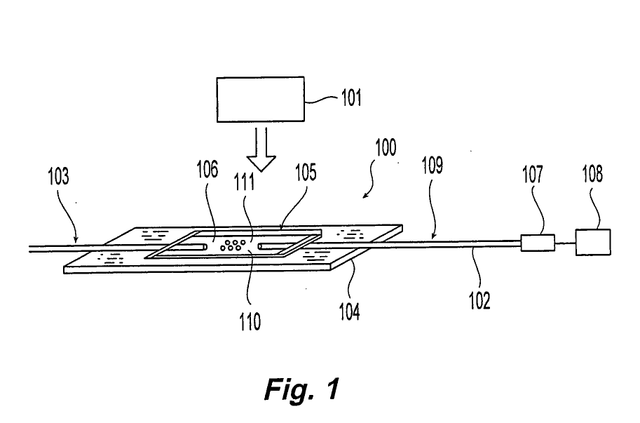

FIG. 1 is an illustration of an assembly sample cell 100 used in a HOT system. A 60× high numerical aperture (n.a.=1.4) oil immersion objective, for example, may be used in the HOT system 101. A flow or sample cell 100 may be created by affixing the input flow tube 102 and output flow tube 103 (for example, Tygon tubing, with an inner diameter (ID)=0.40″, and an outer diameter (OD)=0.07″), to a cover slip 104 (e.g., 50 mm by 22 mm #1), with an epoxy gel 105 (e.g., Devcon Five Minute Epoxy Gel), and then placing a standard glass slide 106 on top of the epoxy gel 105. The electrolyte input tube 102 may be connected to a 3 mL syringe 107, for example, and a syringe pump 108 (e.g., a WPI SP2001), which may be used to control the flow rate of an electrolyte solution 109 into the sample cell 100. In a HOT process, a sample chamber 111 of the sample cell 100 is filled with a particle suspension (e.g., a colloidal particle suspension), which includes particles or cells 110 to be configured. A non-limiting example of a HOT process is provided in Example 1, below.

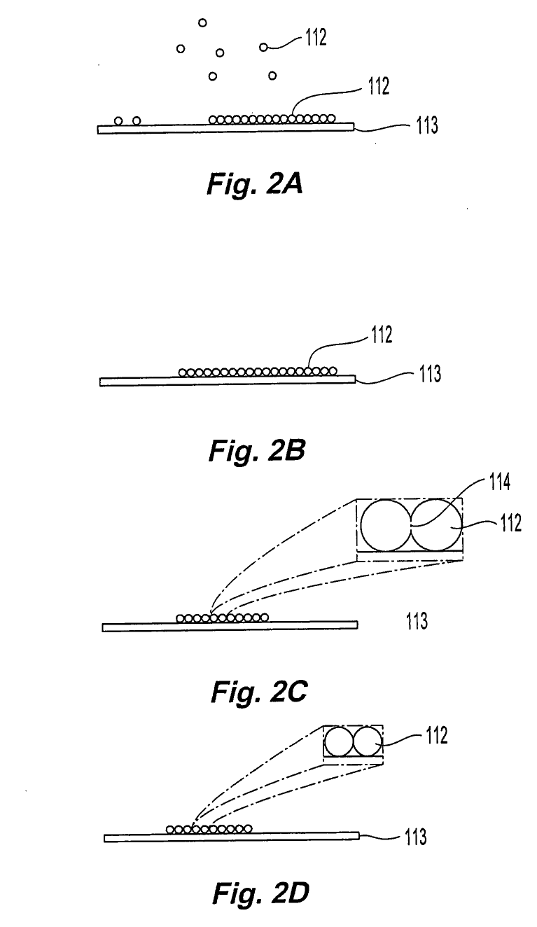

FIGS. 2-4 depict masking processes in accordance with example embodiments. The procedure of forming patterned particles onto a first substrate should produce a template that could act as an effective “mask” that may be capable of patterning substrates with nanoscale features. In the case of a “mask,” the chemical morphology of the patterned substrate may be designed to exclude an additional chemical species, referred to herein as a “first modifier” or “blocker” 117 from a certain volume of space.

Referring to FIG. 2(a), particles 112 may be positioned on a substrate 113, e.g., using the HOT process and organized into the desired pattern on the substrate 113. (In example embodiments where a HOT process is used, particles 112 in FIGS. 2-4 correspond to particles 110 in FIG. 1, and substrate 113 in FIGS. 2-4 corresponds to coverslip 104 in FIG. 1). A destabilizing agent may be introduced into the sample cell which induces particle aggregation to the desired surface (see FIG. 2(b)). Although the pattern of particles on a substrate depicted in some of the example figures (e.g., FIG. 2(b)) may appear two-dimensional, it is contemplated that the particles may be formed into three-dimensional configurations. This example patterning procedure is quite advantageous as it does not require lithography and user-specified patterns of microparticles can be created. This capability to produce functionalized substrates with features on a nanometer length scale is highly desirable for example, for genomic analysis and nanoscale self-assembly.

According to example embodiments, after the aggregation process is complete, the patterned substrate may be removed from solution, e.g., via evaporation or critical point drying. After being removed from solution, the substrate may be trimmed such that only the patterned portion of the substrate remains.

According to example methods, the mechanical strength of the patterned substrate can be further increased by sintering the particles (i.e., lightly melting one or both of the materials), as depicted at location 114 of FIG. 2(c), or cross-linking the particles together. According to other example methods, the particles are not sintered together, as depicted in FIG. 2(d).

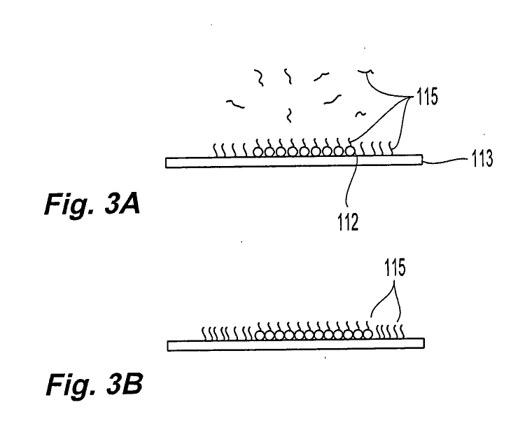

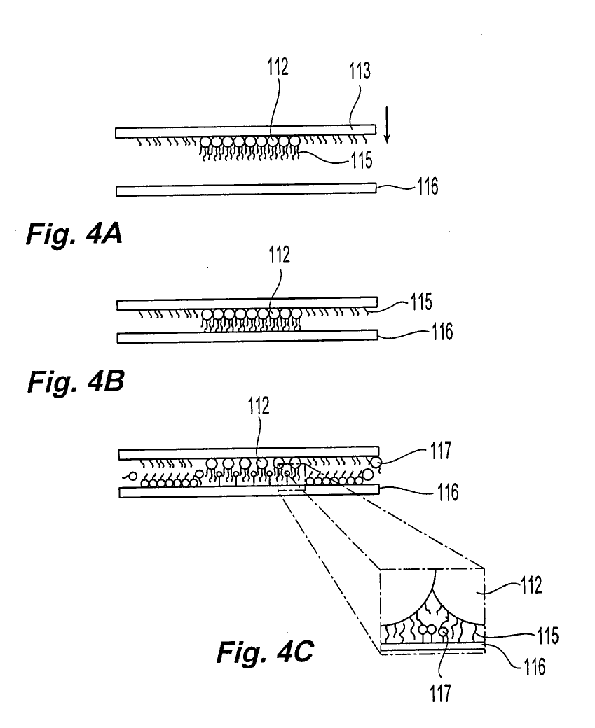

According to non-limiting embodiments, the chemical morphology of the affixed particles may be modified, for example to include one or more linker molecules 115 (or “first modifiers”). The linker molecules may act for example, as a spacer 115 between the particles 112 and a second substrate 116 (also referred to herein as a “print substrate”) as shown in FIGS. 3 and 4. The attachment of the first modifier 115 in a liquid phase, for example, is depicted in FIG. 3(a) and the removal of first modifier 115 is depicted in FIG. 3(b).

Accordingly, example methods may include adding one or more linker molecules to the particles before contacting the particles with a second substrate. Ultimately, the patterned first substrate is placed in intimate contact with a second substrate 116 to act as a “mask” (see FIG. 4(b)). So the linker molecule 115 may be useful, e.g., as a bumper, in preventing particles 112 from adhering to the second substrate 116, when the patterned particles are placed in intimate contact with the second substrate 116. This linker molecule 115 may be covalently or non-covalently attached to the particle surface. By way of non-limiting example, linker molecules or first modifiers may include aminopropyltriethoxysilane or mercaptopropyltrimethyloxysilane, or any molecule that can be covalently attached to silica (i.e., silane). Furthermore, careful choice of the second substrate 116 can ensure the van der Waals interaction between the colloid and second substrate is minimized.

The first substrate having colloidal particles thereon (and optionally linker molecules) is then positioned over a second substrate 116 with the desired functionality and brought into contact with the second substrate 116 (FIGS. 4(a) and 4(b)), such that the colloidal particles either directly contact the second substrate (not shown), or indirectly contact the second substrate, e.g., via the linker molecules (FIG. 4(b)). By way of non-limiting example, the second substrate may include plain glass, gold-covered glass, or polystyrene.

After the patterned substrate is placed into contact with the second substrate 116, the contact areas existing between these two surfaces (e.g., the surfaces of the second substrate and linker molecule attached to colloidal particles) can be made inaccessible to certain species of second modifier molecules 117 (see FIG. 4(c)). The contact area which is capable of excluding some volume of second modifier molecules (or blocking molecules) may be highly dependent on: the applied mechanical force, the surface tension existing between the chemically-modified patterned substrate and the blocking molecule (or the solution containing the blocker), the mechanical constants of the particles (e.g., colloidal particles) and the second surface, the radii of the particles, and the lengths of the optional spacer and the blocker. Furthermore, the contact area will depend on the electrostatic (both Coulombic and van der Waals) and chemical interaction between the functionalized patterned first substrate and the second substrate/print surface. For instance, if the linking molecule and the blocking molecule are oppositely charged, one would expect a greater contact area to exist between the patterned first substrate and the printing surface when all other parameters are kept similar.

A blocking molecule 117, which will adhere to the second substrate 116, may be added while the particles 112 are (directly or indirectly) in contact with the second substrate 116. The particles may be held in contact with the second substrate and the setup may be allowed to incubate for an amount of time such that a desired amount of blocking molecule 117 binds to portions of the second substrate not in contact with the particles.

The source of the blocker and any unbound blocker may be removed (e.g., by flushing in the case of a liquid system, or degassing in the case of a gaseous system).

Suitable example “blockers,” “blocking molecules,” and “second modifier” (which terms are used interchangeably herein), may include any molecule that may directly or indirectly bind to the second substrate. Example blockers may perform the function of blocking a later-applied substance (such as a printing material or printing agent) from binding to the same location on the second substrate. Non-limiting example blocking molecules may also be capable of being removed from the second substrate, without significantly affecting the later applied substance. Other example blockers may serve to functionalize areas of a surface, e.g., to allow specific substances to bind thereto. Non-limiting examples of suitable blocking molecules may include aminopropyltriethoxysilane, protein, or an alkane thiol.

The first and second substrates are then separated from one another yielding the second substrate having blocking molecules bound thereto 118, with features reflecting the geometry of the patterned substrate. (See FIG. 4(d)). When the template is removed from the second substrate, the second substrate has portions 119 of unexposed prepared substrate between the blocking molecules 117. The majority of the printing surface may be functionalized with the blocker chemical species 117. However, the contact areas 119 existing between the patterned substrate and the printing surface will be devoid of this new chemical species. In this manner, the reverse of the patterned substrate 113 has been reproduced on printing surface 116.

Fundamentally, the masking processes are driven by steric hindrance. In example embodiments, the physical size and the density of the linker molecule 115 prevent the blocker 117 from accessing the volume of space existing between the contact areas of the patterned substrate and the printing surface. (See FIG. 4(c)). On an atomic level, this effect can be attributed to the inability for electrons to occupy the same quantum state (the Pauli Exclusion Principle).

Example techniques may be especially efficient when blocker 117 is much larger than linker molecule 115 and/or the interaction between linker molecules 115 and the printing substrate 116 is attractive. These embodiments also allow for the use of modifiers (115 and 117) that are miscible (i.e., soluble). This freedom can be quite important in a liquid-based system where the surface tension existing between the functionalized/patterned substrate and blocker 117 (or the solution containing blocker) should be low. If this is not the case, blocker 117 may not be able to access the interstitial spaces existing between the patterned colloidal particles. This would result in masking failure.

To estimate the feature size produced by the present masking techniques one can use the Chord Theorem. In this approximation, the contact area between a sphere and plane is given by:

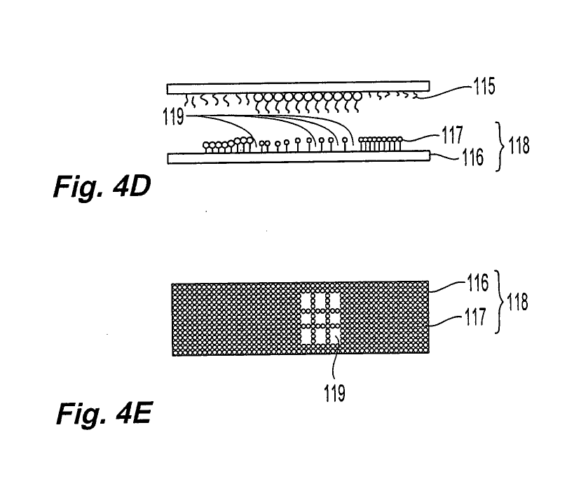

πx²≈2πRz

where R is the radius of the sphere (colloid particulate) and z is the distance separating the two surfaces, and x is the radius of the contact disk. This approximation is valid when z<<R. (See FIG. 5). This estimation does not account for any deformation occurring between the relevant substrates. However, models capable of accounting for this effect are well established. Furthermore, this effect can be minimized by controlling the applied force.

With the choice of chemical modifiers (i.e., linker molecules and blockers), example masking processes are capable of producing copies of the original patterned substrate using the newly patterned surface 119 and self-assembly techniques. An example of such a method is set forth in Example 2 herein.

The second (or print) substrate 119 having blocking molecules bound thereto, may now undergo printing in which the entire prepared second substrate (or a desired portion thereof may be exposed to a desired printing material that only binds to the masked portions 119 of the printing surface to produce a patterned substrate for additional use.

This second substrate having blocking molecules bound thereto 118 may act as an additional template. For instance, the final printing material or “ink” could be a molecule (such as an amine molecule), capable of producing an ionic bond with a negatively-charged surface. Other examples of suitable printing material may include: DNA, proteins, or charged colloid particles. Thus, if such a molecule is printed onto the unblocked portions of the second substrate, DNA, proteins, charged colloid particles, or other substances, may now be attached to the second substrate in essentially the same pattern as the colloid particles on the first substrate.

The above steps may optionally be repeated one or more times on the second substrate or on third or more substrates. Therefore, the first assembly process utilizing HOT may be likened to forming a master template on the first substrate. After the master template is formed, additional colloid templates may be formed by guided self-assembly.

Both the mask and printing methods provided herein may be performed manually by a person with the assistance of a mechanical stage capable of positioning a substrate with nanometer resolution in the x, y, and z dimensions. Furthermore, this device should also be capable of applying pico to micro Newton forces. It is contemplated that such methods may be automated.

Also included herein are substrates having blocking molecules bound thereto produced by the above methods. Further included are substrates patterned with molecules capable of producing an ionic bond between a charged surface, which may be prepared by the present methods. Further included, are products incorporating functionalized substrates made by the present methods.

Another example application of the present invention is printing, such as nano-printing. The capability to form patterned substrates with characteristic feature sizes on a nanometer length scale may be highly desirable for genome chips, for example.

According to non-limiting embodiments, printing methods are provided that include assembling multiple particles, such as colloid particles, into a desired pattern on a first substrate; contacting a print material with the particles such that at least a portion of the print material binds to the particles (or binds to a third modifier, such as a linker molecule bound to the colloidal particles) on the first substrate; removing the first substrate having particles thereon from any unbound print material; contacting the particles having print material bound thereto with a second substrate such that at least a portion of the print material binds to the second substrate; and separating the first and second substrates, such that the second substrate is now a printed substrate.

FIGS. 2 and 6-8 depict an example printing processes in accordance with example embodiments. As in the above methods, example printing methods include assembling multiple particles into a desired pattern on a first substrate to form a template. The template may be prepared as explained in other embodiments herein, (including the examples), for example by using a HOT process (see FIGS. 1 and 2). For example, referring again to FIG. 2(a), particles 112 may be assembled on a substrate 113 using the HOT process and organized into the desired pattern on the substrate 113. (In example embodiments where a HOT process is used, particles 112 in FIGS. 2 and 6-8 correspond to particles 110 in FIG. 1, and substrate 113 in FIGS. 2 and 6-8 corresponds to coverslip 104 in FIG. 1). Then a destabilizing agent may be introduced into the sample cell which induces aggregation to the desired surface (see FIG. 2(b)). Particles and the first substrate in these example methods may be as described herein with respect to other example embodiments.

According to example printing methods, the procedure of forming patterned particles onto a first substrate will produce a template that could act as an effective “print-head.” The template/print-head may be capable of patterning substrates with nanoscale features.

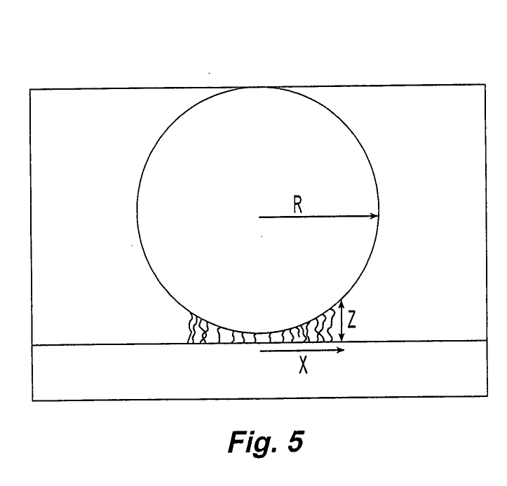

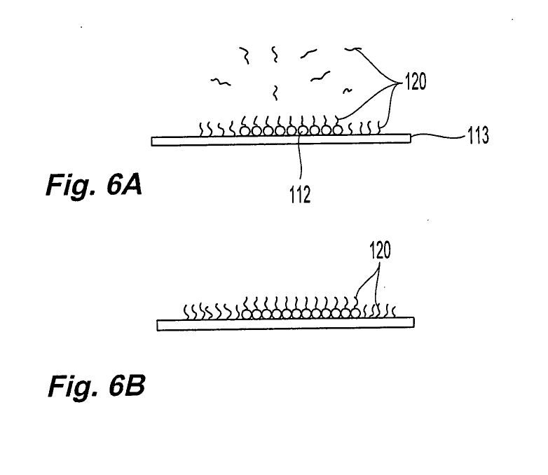

According to non-limiting example embodiments, similarly to the masking methods provided herein, the chemical morphology of the affixed particles may be altered to include at least one linker molecule (third modifier). The third modifier may act as a spacer 120 between the particle 112 and print material 121 to be deposited on a second substrate 116, as shown in FIGS. 6 and 7. According to example embodiments, the surface chemistry of the assembled particles can be altered e.g., by a third modifier, to ensure binding of a print material to the particles, thus functionalizing the particle surface. Accordingly, example methods may include adding one or more linker molecules to the particles before contacting print material with the particles. The linker molecule may bind to a print material via a non-covalent or covalent bond. Ultimately the patterned surface is placed in intimate contact with a second substrate 116 to act as a “print head.” So to prevent the particles 112 from adhering to the second substrate 116, the linker molecule 120 can be introduced to act as a “bumper”. This linker molecule 120 may be covalently attached to the particle surface or adhered simply by an ionic interaction.

Furthermore, careful choice of the final printing substrate can ensure the van der Waals interaction between the print head and print substrate 116 is minimized. By way of non-limiting example, suitable linker molecules (third modifier) for silica-based colloid may include oxysilanes terminated with a thiol or amine.

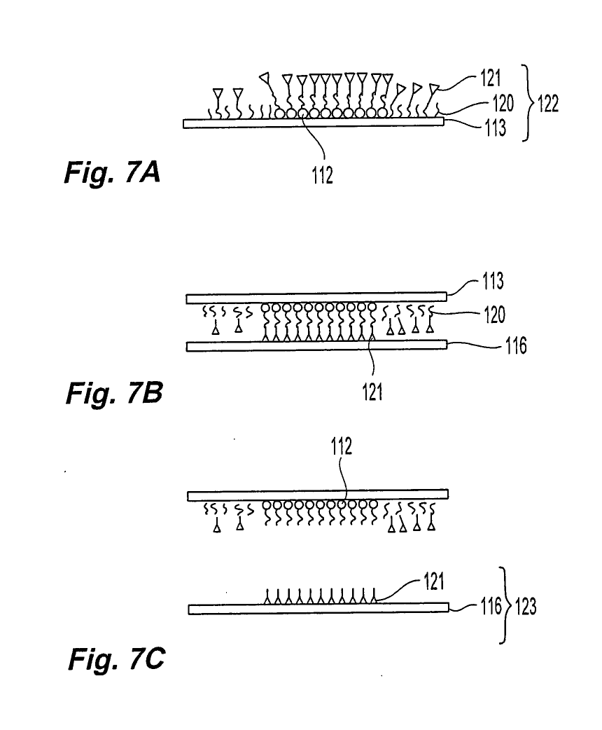

In example methods, a print material 121 (fourth modifier) is contacted with particles 112, such as colloidal particles, directly (see FIG. 8(a)) or indirectly—e.g., via linker molecules (see FIG. 7(a)) such that at least a portion of the print material 121 binds to the particles 112 on the first substrate 113 (see FIGS. 8(a) and 7(a)). The particle template, which includes the first substrate having particles patterned thereon, may be contacted with print material, for example, by being dipped in a print or “ink” material or exposed to “ink” vapor before being put in intimate contact with a prepared second substrate. By way of non-limiting example, the print material may be introduced into a sample cell in which a HOT process may have been used to manipulate particles on the first substrate.

By way of non-limiting example, suitable print material may include cleavable bifunctional crosslinkers, fluorescently labeled proteins, antigens or antibodies, or strands of DNA.

The entire first substrate having particles thereon and a portion of the print material directly or indirectly bound to the particles 122, is then removed from the portion of the print material (e.g., via evaporation or critical point drying if compatible) or vapor that has not bound to the particles (or the unbound print material may be removed from the substrate).

The present techniques may find greatest ease of use when the print material 121 is an easily vaporizable material, in accordance with example embodiments. The use of a vapor “priming” (i.e., coating of linker molecule 120 with print material 121 as shown in FIG. 7(a)) should allow very careful control over the amount of print material deposited on the functionalized and patterned substrate. If print material 121 is incapable of being vaporized effectively (large biomolecules are an example) a liquid-based deposition of this species may be required. Careful control over binding energies should ensure that the apex of each microparticle remains coated with at least one molecular layer of print material.

An additional complication this “print” methodology may face is the vapor pressure of print material 121. If this species is only weakly bound to the patterned substrate, after it is removed from solution or the source vapor, molecules of this species will begin to break free of the patterned substrate. This effect can be countered by choosing materials with intrinsically low vapor pressures or increasing the strength to which linker molecule 120 is bound to the patterned substrate. In example embodiments, the patterned substrate can be modified with a reagent that increases the polarity of the surface functionality. If print material 121 is also polar, this change should result in an increased binding interaction existing between linker molecule 120 and print material 121.

According to example methods, the entire first substrate having particles thereon and print material bound thereto 122 is positioned over a second substrate 116 with desired functionality and brought into contact with the second substrate 116 (FIGS. 7(b) and 8(b)) such that at least a portion of the print material binds to the second substrate 116. The particles 112 on the first substrate 113 may be held in contact with the second substrate 116 (as shown in FIGS. 7(b) and 8(b)) if desired, to allow the print material to bind to the second substrate. The second substrate in these example methods may be as described herein with respect to other example embodiments.

The first and second substrates are then separated from one another (see FIGS. 7(c) and 8(c)) leaving at least a portion of the print material 121 bound to the second substrate 116, such that the second substrate is now a printed substrate 123. Various factors determine the printed feature size, including: the applied mechanical force, the mechanical constants of the particles and the second surface, the radii of the particles, and the length of the optional linking molecule. Furthermore, contact area will depend on the electrostatic (both Coulombic and van der Waals) and chemical interaction between the functionalized patterned first substrate and the second substrate/print surface.

Print material may be made or selected to bind to a printing surface (second substrate) with greater strength than it binds to a linker molecule (if present) or to the particles (if no linker molecule is present). Thus, after the patterned surface is exposed to print material, placed into contact with the printing surface, and treated with a release agent that ensures that print material 121 is released from particle 112 or linker 120 (if necessary), the contact areas existing between the two surfaces should become essentially coated with print material. An example of such a release agent is the reducing agent dithiothreitol (DTT) in the case of a heterobifunctional crosslinker such as dithiobis[sulfosuccinimidylpropionate] (DTSSP).

With the choice of third and fourth chemical modifiers (including e.g., the linker molecule and print material), the present printing techniques are capable of producing chemical features on the nanometer scale.

The above steps including coating of the template of the first substrate having particles thereon with ink, and/or of printing that ink onto a second substrate (or optionally third or more substrates), may be repeated one or more times, for example to form densely packed nanometer scale features on a macroscopic area.

Further included herein are printed substrates produced by the above methods, and products, such as genome chips, security identification patterns, photonic devices, and diagnostics arrays that include such printed substrates

Example embodiments of the present invention are further directed to kits that include at least one component for performing the methods provided herein. By way of non-limiting example, kits may include an apparatus for assembling a multi-particle structure on a substrate that includes holographic optical tweezers, which form optical traps and a sample cell including a substrate, a sample chamber on the substrate, an input tube into the sample chamber and an output tube from the sample chamber.

For masking processes, kits may include various items including any combination of particles (such as colloidal particles), substrates, blocking molecules, linker molecules, and the like. For printing processes, kits may include various items including any combination of particles (such as colloidal particles), print material, substrates, linker molecules, and the like. Such kits may further include one or more printing materials (or agents) or substance to be bound to the printing materials (e.g., proteins, negatively charged colloid particles, etc.).

Numerous possible additions to kits may be contemplated by those skilled in the art reviewing this disclosure. For example, kits may further include one or more other devices, tools, materials, and the like that may be useful in conjunction with the present methods.

Also provided herein are kits that include at least one substrate produced by any of the methods herein, such as printed substrates, substrates having blocking molecules bound thereto, and substrates having blocking molecules bound thereto that are patterned with a printing material. Further provided are kits that include at least one product incorporating a substrate produced by any of the methods herein.

Exemplary embodiments of the present invention are further directed to systems that include at least one component for performing the methods provided herein. By way of non-limiting example, such systems may include an apparatus for assembling a multi-colloidal structure on a substrate that includes holographic optical tweezers, which form optical traps and a sample cell including a substrate, a sample chamber on the substrate, an input tube into the sample chamber and an output tube from the sample chamber.

For masking processes, systems may include for example, particles (such as colloidal particles), substrates, blocking molecules, linker molecules, and the like. For printing processes, systems may include for example, particles (such as colloidal particles), print material, substrates, linker molecules, and the like. Such systems may further include one or more printing materials (or agents) or substance to be bound to the printing materials (e.g., proteins, negatively charged colloid particles, etc.)

Numerous possible additions to systems may be contemplated by those skilled in the art reviewing this disclosure.

Also provided herein are systems that include at least one substrate produced by any of the methods herein, such as printed substrates, substrates having blocking molecules bound thereto, and substrates having blocking molecules bound thereto that are patterned with a printing material. Further provided are systems that include at least one product incorporating a substrate produced by any of the methods herein.

The systems herein may further include computers, software and/or other devices that may be used for example, in the automation of any of the present methods, and/or in the use of any of the products made by the present methods.

The following examples illustrate non-limiting embodiments. The examples set forth herein are meant to be illustrative and should not in any way serve to limit the scope of the claims. As would be apparent to skilled artisans, various changes and modifications are possible and are contemplated and may be made by persons skilled in the art.

### Example 1

In this example, colloidal particles were manipulated into a desired configuration using HOT. The HOT process begins by filling a sample chamber 111 (see FIG. 1) of a sample cell 100 with a charge-stabilized colloidal suspension—e.g., a solid phase that includes particles or cells with a characteristic size of tens of microns to one nanometer, that when dispersed in a continuous phase, acquire a surface charge. A commercially available monodisperse silica colloid (such as Bangs Laboratories #SS04N/5569) with a diameter of 2.34 μm, was used in this example.

After the sample chamber 111 was filled, the sample cell 100 was sealed with epoxy 105. The silica colloid was used as-is, without any surface modification and dispersed in filtered water (such as Bamstead Nanopure—pH adjusted to approximately 7.0 with 0.05 M NaOH) to produce a concentration of approximately 1×10⁶ particles/mL, for example.

The sample cell 100 was placed on a microscope stage (not shown) and the colloid particles 110 were allowed to sediment to the coverslip surface 104. This concentration produced a two-dimensional packing fraction of approximately 2%, which achieved an excellent balance between availability of free particles 110 and open space to form structures.

Colloid particles 110 were then trapped with the holographic optical tweezers 101 and held in place away from each other and the walls of the chamber 111 of the flow cell 100. About 10 to 50 particles 110 were acquired in each assembly step with an average single trap power of 18 to 90 mW, for example. These trap powers ensured that trapped particles 110 could withstand viscous drag forces associated with introducing the electrolyte solution 109 into the cell 100. However, one of ordinary skill in the art would know that the power needed for trapping will vary with the size and type of particles, etc.

After the colloid particles 110 were trapped, an electrolyte solution (such as 0.2 M NaCl Sigma Aldrich #S-7655) 109, for example, was flowed into the sample cell 100. Although diffusion can produce the desired effect by simply introducing electrolyte 109 into the input syringe 107, flowing electrolyte solution 109 into the sample cell 100 ensured that essentially the entire cell volume had the same concentration of electrolyte 109 as the source 107. A flow rate of approximately 0.1 mL/min was used, for example, depending on the number of particles 110 trapped. The electrolyte 109 flow was approximately one to two times the sample cell volume into the cell 100. However, one of ordinary skill in the art would be able to determine what electrolyte and what flow rate and concentration should be used with the particular colloid chosen.

A few untrapped particles 110 were left in the field of view of the sample chamber 111 as indicator particles, to observe the aggregation process. After the thermal motion of these indicator particles stopped, trapped particles 110 were brought into contact using HOT, with the coverslip 104 or with each other by either placing individual particles 110 on the surface of the coverslip 104, or in contact with neighboring particles 110. Accordingly, these particles 110 could be assembled into multi-dimensional structures.

Additionally, entire groups of particles 110 could be brought into contact with the coverslip (substrate) 104 by adjusting the focal length of entire groups of the trapped particles 110 using the HOT 101. All particles 110 aggregated within approximately four seconds of being brought into contact with each other or the substrate 104.

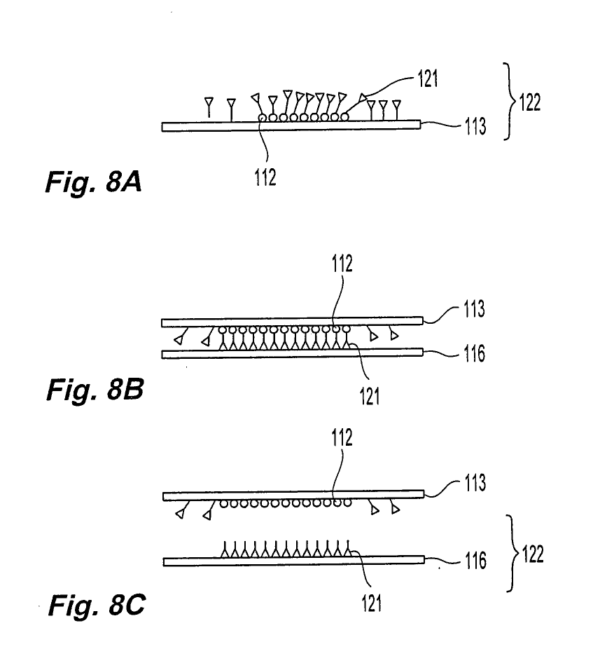

FIG. 9 is a collection of images illustrating the assembly process of 3×3 colloidal crystal in free space using HOT 101.

In the example shown in FIG. 9(a), nine particles 110 were trapped and separated and held apart from the glass coverslip 104 and each other. The particles 110 were separated from neighboring surfaces by approximately 2 μm, for example. A 0.2 M NaCl electrolyte solution 109, for example, was then introduced into the sample cell 100, and the particles 110 were combined into a two-dimensional (2D) simple square lattice pattern (see FIG. 9(b)) to form three 3×1 arrays 112 (see FIG. 9(c)), until a 3×3 crystal 124 was formed and suspended above the substrate by approximately 10 μm.

In FIG. 9(d), the crystal 124 was rotated 90 degrees above the substrate about an axis parallel to the coverslip 104 using four optical traps, and then rotated again by 45 degrees before being deposited on the substrate 104. One skilled in the art would know that the crystal 124 could be rotated by any degree to show manipulation in three dimensions.

In this case only one particle 110 was in contact with the coverslip 104 surface. Tweezing with single or multiple traps with a net power of approximately 1 W had no clear effect on the structure 124 once it was positioned on the glass substrate 104.

In FIG. 9(e) the structure 124 was rotated once more by changing the focal length of three optical traps, and deposited on the substrate 104 to produce a 3×3 crystal 125 in a diamond-like orientation. No optical traps were present in the final image. The scale bar is 5 μm. Thus, an assembled three-dimensional structure was obtained. Assembled colloid structures may be deposited in other formations on substrates as well.

The behavior described above, can be understood with the celebrated DLVO theory of colloidal stability. The DLVO theory is named after Dedjaguin, Landau, Verwey and Overbeek who developed it in the 1940s. The theory describes the force between charged surfaces interacting through a liquid medium. It combines the effects of the van der Waals attraction and the electrostatic repulsion due to the so-called double-layer of counterions. Under the initial prepared conditions, the silica (colloid) particles 110 and the glass surfaces 104 develop a negative surface charge principally caused by the disassociation of terminal silanol groups. At low electrolyte 109 concentrations and pH higher than the isoelectric point of silica (of the particles 110) this surface charge prevents particle flocculation and aggregation to the glass surfaces 104. This allows the use of HOT to trap particles for use in subsequent assembly. One of ordinary skill in the art would know that this behavior would be shown if particles made from other than silica were used.

The electrolyte concentration may be sufficiently large to completely suppress the repulsive electrostatic contribution to the interaction potential. However, an additional possibility is to precisely tailor the electrolyte concentration such that without an additional attractive potential the aggregation rates are minimal. This concentration depends strongly on the properties of the suspension and substrate. However, if tuned correctly, the suspension could be made to remain quasi-stable until the additional potential of an optical trap acts on a particle. In this way, a particle could remain largely unbound in solution until a trap applies sufficient force to lock the particle in place.

These techniques can also be induced by altering the surface charge of the colloidal suspension and substrate 104 by adjusting the pH of the sample cell 100. The level of surface ionization—and therefore surface charge—depends on the pH of the continuous phase. By adjusting the pH (to an acidic or basic level depending on the charge species) the magnitude of the repulsive interaction can be reduced such that even at low electrolyte concentrations where the Debye length is large the repulsive electrostatic barrier is not large enough to prevent aggregation. Therefore this same technique of introducing a destabilizing agent into a sample cell 100 containing a colloidal suspension assembled into a specific configuration can be accomplished by tuning the sample pH.

Each of these methods (i.e., adjusting electrolyte concentration and/or pH) can also include suspensions that include two or more different colloidal species. As the rate of aggregation in either scenario (adjusting electrolyte concentration and/or pH) depends strongly upon the material properties of the colloid, the conditions of the sample cell 100 could be made such that only one portion of the population would aggregate. Therefore the possibility exists for forming structures composed of multiple colloid types in the same sample cell in a step-wise manner.

Because each of these methods does not permanently alter the chemical morphology of the suspension or chamber the assembly process can be repeated multiple times. After the fixation process is accomplished by introduction of electrolyte or pH adjusted solution, the sample cell 100 can be flushed with a solution that increases the electrostatic repulsion of the suspension. Because the attractive van der Waals potential is negligibly influenced by pH or electrolyte concentration it remains the dominate term in the interaction potential at the nanometer and sub-nanometer separations existing between the relevant surfaces. Therefore particles that are initially bound will remain in that state even though a fresh suspension will remain unbound. More or different colloids can be added to the sample cell and then the fixation process can be repeated until the desired final structure is assembled. This capability will allow for ultra-large and complex structures composed of multiple colloid species to be formed. These structures can be attached to a substrate, as shown in FIG. 9(e), where the 3×3 crystal structures 124, 125 were obtained and deposited on a surface of a substrate 104.

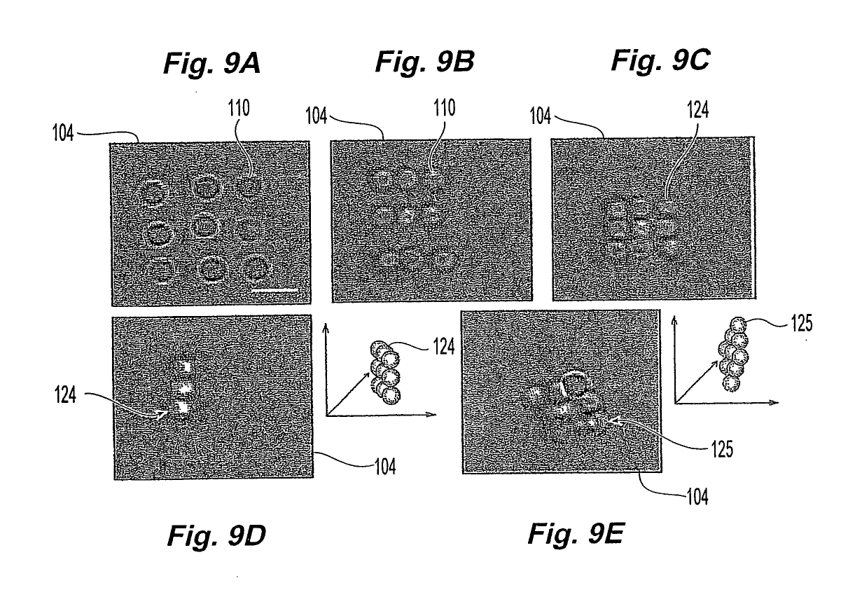

Several example multi-dimensional colloid structures have been made using the HOT processes. FIG. 10 shows a brightfield image of a larger (n=40), three-dimensional (3D), two layer colloidal crystal 126 composed of 2.34 μm silica particles 110, for example (although any type of charge-stabilized colloid that can be trapped can be used), which are formed on a glass coverslip substrate 104. In this case, two layers 127, 128 of particles 110 which are optically trapped, are each arranged into a hexagonal pattern at different focal lengths and then a 0.2 M NaCl electrolyte solution, for example, is introduced.

The initial (first) layer 127 of particles 110 was deposited on the substrate 104 by reducing the focal length of the collection of the traps until all of the particles 110 in the first layer 127 were in contact with the coverslip 104. After this initial layer 127 was deposited, individual particles 110 were positioned, particle 110 by particle 110, within the lattice to form a second layer 128. After each particle 110 was deposited, the optical traps were removed from the structure 126. No optical traps are present in the final image. The arrow 129 indicates a defect. The scale bar is 5 μm.

Once the particles 110 were adhered to the substrate 104 or each other, using for example, the fixation process described herein, subsequent additional optical tweezing had no apparent effect on the position of the particle 110 even at trap powers approaching 1 W, for example. This is to be expected since the energy of the applied optical trap (about 50 k_{b}T, for example), is much less than the typical van der Waals energy (about hundreds to thousands of k_{b}T, for example) at nanometer and sub-nanometer length scales.

HOT methods, such as those described in this example, can be used to build a three-dimensional colloidal structure composed of two or more differently sized colloids. Such three-dimensional structures may be used in accordance with the present methods.

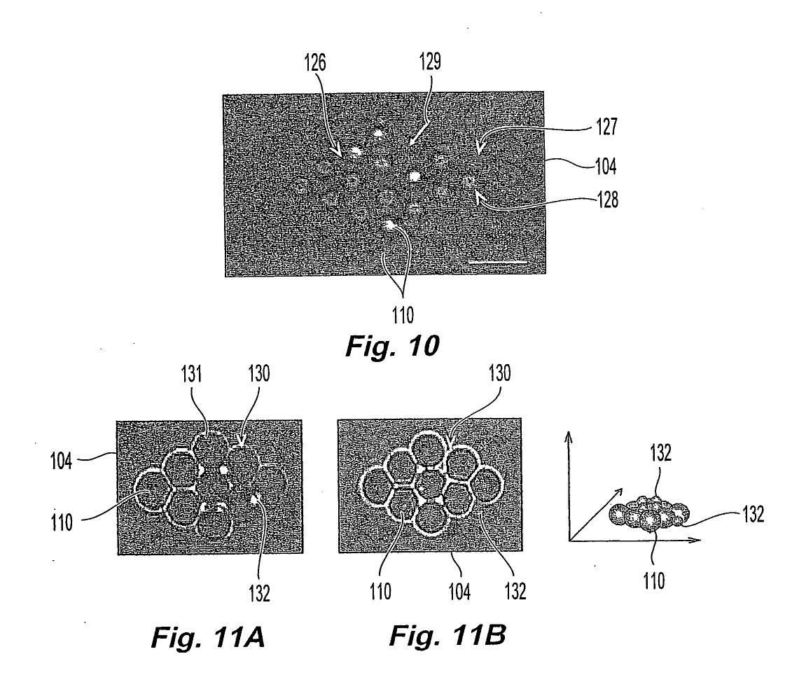

FIG. 11 is a brightfield image of the complete structure 130 formed from two populations of differently sized silica spheres. FIG. 11 shows a crystal 130 formed from 4.50 and 2.34 μm silica spheres (such as a Bangs Laboratories #SS059/4908), used as the colloid, for example), which are dispersed together in the sample cell 100, trapped, and then organized as in previous experiments.

In this process, a 0.2 M NaCl solution, for example, was flowed into the sample cell 100 and a single layer 131 of 4.50 μm silica, for example, is assembled into a two-dimensional hexagonal close packed (HCP) lattice on the class coverslip 104.

Then, five 2.34 μm silica particles 132, were deposited over the first layer 131 of colloid. Specifically, an initial layer 131 of 4.50 μm silica, for example, is deposited in a HCP pattern, and 2.34 μm silica 132, for example, is deposited at the junction of three larger particles 110. In addition, one smaller particle 132 is placed at the junction of two particles 110.

The assembled structures can be brought into contact with the glass substrate using HOT and the fixation process to allow attachment in specific locations to the substrate. The assembled structure/substrate system can be removed from the sample cell for use in subsequent applications. Many of these structures can be removed from solution without the aid of critical point drying.

To demonstrate this, one side of the chamber 111 (see FIG. 1) was sealed with a hot glue rather than epoxy. Once the structure 124 (see FIG. 9(c)) was formed, the hot glue was liquefied using a soldering iron and one side of the chamber 111 was exposed to atmosphere. The aqueous phase was allowed to evaporate from the sample cell 100. This process takes several hours depending on the proximity of the structure 124 to the open edge of the sample cell 100 and the thickness of the sample chamber 111.

FIG. 11(b) is a brightfield image of the same structure 130 as in FIG. 11(a) after the aqueous phase has been removed (i.e., allowed to evaporate). The arrow indicates a 2.34 μm particle 120 that shifted position during the removal of the aqueous phase. The scale bar is 5 μm.

From the above, it can be seen that three-dimensional structures bound to a surface by a single connection, or crystals with large lattice constants typically undergo deformation upon drying. This observation is understandable given the low number of particle/particle and particle/substrate adhesion points and the large surface area of the structure 130.

### Example 2

In this prospective example, a patterned substrate may be copied without the need for repeated HOT assembly processes.

According to this example, a mask process as set forth above is used, in which the relevant surfaces, i.e., colloidal particles 112 and printing surface (second substrate surface 116) are silica-based. The patterned first substrate may be modified with an amine-terminated silane 115 (first modifier) such as aminopropyltriethoxysilane. This reagent will react with silanol groups on the surface of both the glass substrate 113 and silica-based colloidal particles 112. The now modified patterned substrate can be used as a mask to prevent additional aminopropyltriethoxysilane (blocking agent) 117 from accessing the contact areas between the patterned first substrate and glass print surface (second substrate). Excess blocking agent (aminopropyltriethoxysilane) is then removed which is then followed by the removal of the patterned substrate. The result should be a printing surface 118 with silanol functionality (from the second substrate) where the patterned substrate and printing surface were in contact 119 and amine functionality (from the blocking agent) where the two surfaces were not in contact 117.

When this printed surface is exposed to water above a certain pH, distinct regions of positive (amine functionality) and negative (silanol) charge should be present. If this substrate were exposed to positively-charged colloidal particles, one would expect the particles to remain free of the amine-functionalized portions of the substrate and electrostatically bind to silanol-functionalized portions of the substrate. The rate at which these new particles bind to the substrate can be controlled by altering the pH of the solution. Control over this parameter will ensure that the particles bind to the center of each feature.

After the colloidal particles spontaneously assemble into the pattern printed on the printing surface (which corresponds to the pattern of colloid particles on the first substrate), they can be fixed in place via a destabilization process as described earlier or covalently attached via a silane coupling agent such as tetraethyl orthosilicate (residual silanol groups tend to remain on silica-based materials even after exposure to a silane agent). These steps should only be necessary if the electrostatic interaction existing between the positively-charged colloidal particles and the negatively-charged printed substrate is not strong enough to permit removal from solution without destruction of the new structure. Once this new structure is removed from solution it can be treated as the original patterned substrate and the process repeated.

In this example, the newly formed structure having colloidal particles patterned thereon should now be in a similar state as the original patterned structure. Therefore these two patterned structures can be combined in an array format and the process then repeated. In this manner the number of distinct features patterned on a substrate increases quadratically with each process (i.e., N² where N is the number of processes). Therefore this example demonstrates the capability for this technique to form copies of an original structure without the need for HOT assembly for each copy.

### Example 3

In this prospective example, a printing technique is described, which is capable of producing chemical features on the nanometer scale. Colloidal silica microparticles may be assembled into a desired template on a silica substrate using known techniques, such as the HOT technique described herein. After the patterned structure/template is formed, removed from solution, and sintered to fuse the colloid particles together, the structure is exposed to an amine-terminated silane agent such as aminopropyltriethoxysilane (linker molecule 120). This treatment produces an amine functionalized patterned surface. After this step is complete, the patterned surface is exposed to a print material 121 containing an amine-reactive and cleavable crosslinker such as dithiobis[sulfosuccinimidylpropionate] (DTSSP). This molecule will covalently bind with available amine groups on the surface of the patterned substrate to produce a surface that is amine-reactive.

The now “primed” patterned substrate is then put into contact with an amine-functionalized print surface (second substrate 116). This step will covalently attach the functionalized patterned surface to the print surface. However, because DTSSP has a disulfide linkage, this covalent connection can be reduced with a small reducing agent such as dithiothreitol (DTT). Therefore the introduction of such a reducing agent will release the two surfaces at the disulfide connection leaving the patterned substrate and the print surface with thiol functionality. The print surface 123 should now have thiol functionality where the patterned substrate and printing surfaces were in contact and amine functionality where the two surfaces were not in contact.

The print surface can now be further modified if desired to selectively bind to a new material (via a covalent crosslinker or a semi-specific interaction) such as protein or DNA.

This technique can also be used to produce copies of the original template. For example, the thiol-patterned print surface can be exposed to a thiol and amine reactive bifunctional crosslinker. Once this step is complete, the substrate can be exposed to amine-functionalized colloidal particles. The particles should spontaneously self-assemble onto the locations where the original patterned substrate was in contact with the print surface. Therefore this technique is capable of producing copies of the original patterned substrate.

This “printing” technique can be used to produce copies that can be combined in an array format and the process then repeated. An additional chemical treatment may be needed to restore the original functionalized patterned surface to an amine-reactive state (one possibility is through exposure to a fresh solution of DTSSP). In this manner the number of distinct features patterned on a substrate increases quadratically with each process (i.e., N² where N is the number of processes). Therefore this example demonstrates the capability for this technique to form copies of an original structure without the need for HOT assembly for each copy.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims. Thus, the described embodiments should be considered in all respects as illustrative and not restrictive.

What is claimed is:

1. A masking method comprising:
assembling multiple particles into a desired pattern on a first substrate;
contacting the particles with a second substrate;
adding blocking molecules while the particles are in contact with the second substrate, such that blocking molecules bind to portions of the second substrate not in contact with the particles; and
separating the first and second substrates, yielding a functionalized substrate having blocking molecules bound thereto.

2. The method of claim 1, wherein the particles are assembled on a first substrate using holographic optical trapping.

3. The method of claim 1, further comprising sintering or crosslinking the particles to one another before contacting the particles with the second substrate.

4. The method of claim 1, further comprising adding linker molecules to the particles before contacting the colloidal particles with the second substrate.

5. The method of claim 4, wherein the particles are indirectly contacted with the second substrate via the linker molecules.

6. The method of claim 1, wherein the particles are colloidal particles.

7. The method of claim 1, further comprising exposing the functionalized substrate having blocking molecules bound thereto, with a printing material to produce a patterned substrate.

8. The method of claim 7, wherein the printing material comprises a molecule capable of producing an ionic bond with a charged surface.

9. The method of claim 8, wherein the printing material is selected from the group consisting of DNA, proteins, and charged colloid particles.

10. A functionalized substrate having blocking molecules bound thereto produced by the method of claim 1.

11. A product comprising the functionalized substrate of claim 10.

12. A printing method comprising:
assembling multiple particles into a desired pattern on a first substrate;
contacting a print material with the particles such that at least a portion of the print material binds to the particles on the first substrate;
removing the first substrate having particles thereon from unbound print material;
contacting the particles having print material bound thereto with a second substrate such that at least a portion of the print material binds to the second substrate; and
separating the first and second substrates, yielding a printed substrate.

13. The method of claim 1, wherein the particles are assembled on a first substrate using holographic optical trapping.

14. The method of claim 12, further comprising sintering or crosslinking the particles to one another before contacting the print material with the particles.

15. The method of claim 12, further comprising adding linker molecules to the particles before contacting the print material with the particles.

16. The method of claim 15, wherein the print material is indirectly contacted with the particles via the linker molecules.

17. A printed substrate produced by the method of claim 12.

18. A product comprising the printed substrate of claim 17, wherein the product is selected from the group consisting of genome chips, security identification patterns, photonic devices, and diagnostics arrays.

19. A kit comprising multiple colloidal particles, at least one substrate, and blocking molecules.

20. A kit comprising multiple colloidal particles, at least one substrate, and print material.
